(19) United States
(12) Patent Application Publication
(10) Pub. No.: US 2011/0271203 A1
(43) Pub. Date: Nov. 3, 2011

(54) COLLEGE ADMISSIONS MESSAGING

(76) Inventors: Donald FRASER, Bethesda, MD (US); Conor Shankman, Somerville, MA (US)

(21) Appl. No.: 13/099,332

(22) Filed: May 2, 2011

Related U.S. Application Data
(60) Provisional application No. 61/343,554, filed on May 3, 2010.

(51) Int. Cl. G06F 3/01; G06F 15/16

(52) U.S. Cl. 715/752

(57) ABSTRACT

A college admission messaging system and method are provided. Students and counselors can enter information and receive custom messages related to a particular student's college application process. Students can receive incentives as they complete critical steps in the application process. Students can invite a school counselor (e.g., one or more mentors) to monitor their application progress. School counselors can have access to a computer user interface (e.g., dashboard) to track student participation and progress in the college admission process. Counselors can have the ability to customize the dashboard and messages sent to the students. The counselors can utilize the dashboard to assist students in completing their college admissions tasks. Colleges can used the messaging system to assist newly enrolled students succeed by providing orientation information and performance based updates.

### CROSS-REFERENCE TO RELATED ACTIONS

This application claims the benefit of U.S. Provisional Application No. 61/343,554 filed on May 3, 2010.

### BACKGROUND

In 2010, the CollegeBoard (2010) reported that the United States, which was once the leader in the share of young adults (ages 25 to 34) with a postsecondary degree, has slipped to 12^{th} in the world. In order for the United States to remain competitive in a changing global economy, the country must have a more educated populace. In reality, young students in the United States face substantial issues of access to higher education. For example, there are large disparities in the rates of college enrollment for wealthier Americans as compared to those from lower-income households.

In general, research shows that many students from low-income households (one of our country's fastest growing demographics) do not apply to college, even those that are “college-ready” and capable of handling the rigors of college academics are not applying to go to college. One such study reports that students from low-income households are continuing directly to college at a rate of only 56% as compared to 89% of students from the highest income quartile. Researchers note that this “talent loss” is more widespread than many recognize (see Plank and Jordan, 2001; IHEP; CCSR, 2008). The study also suggests that students from the lowest-income households in the highest achievement quartile enrolled in college at a rate of only 78% as compared to 97% of students from the highest income and highest achievement quartiles. Perhaps more telling is that the lowest achieving, highest income students were enrolling in college at nearly the same rate (77%) as the highest achieving, lowest income students.

Thus, there is a need, as captured by the alarming disparity between the college going, persistence and graduation rates of students from low-income households and their wealthier peers, for a system to help provide the necessary information about the college application process to students from low-income households.

The school counselor (e.g., guidance counselor) can be a logical choice to help such students, but competing responsibilities, increasing student caseloads, and a lack of innovation can limit their effectiveness. By and large, the profession has done business in the same fashion for decades. Typically, the average public school caseload is 311 students to every college counselor. In some public schools, however, the average counselor caseload can be even greater than the national average, and in some states that number can swell to nearly 1000. Thus, there is also a need to improve the quality of student-counselor interactions in schools that maintain such high counselor to student ratios.

In general, students from low-income households, who are also more likely to have parents who are unfamiliar with the college application process, are not getting the information they need to apply to college. These students are more likely to be disappointed with their college choice and less likely to receive financial aid for college. Nonetheless, there are some colleges that recognize these difficulties and are more effective in compensating for any such disparity. Thus, there is also a need to showcase colleges and universities that do an effective job of graduating students from low-income households and other colleges that attempt to correct the disparities described above.

### SUMMARY

In accordance with implementations of the invention, one or more of the following capabilities may be provided. Students can enter personal information such as grade level, course work completed, and contact information. A processor can provide messages (e.g., SMS text, email, social network) about the college application process. Students can receive incentives as they complete critical steps in the application process. Students can invite a school counselor, or other supportive adult (e.g., parent, guardian, mentor, coach, etc.) to monitor their application progress. Students can also be encouraged to interact with a website where select colleges provide admissions assistance. School counselors and other mentors (“counselors”) can have access to a computer user interface (e.g., dashboard) to track student participation and progress in the college admission process. Counselors can have the ability to customize the dashboard and messages sent to the students. The counselors can utilize the dashboard to facilitate counselor-student meetings in order to review the application status or discuss other issues related to the student's academic profile.

In an embodiment, a college admission messaging system, and related methods, provides an educational tool that prompts students to make appropriate educational decisions throughout their middle and high school years that can position them to be viable candidates for admission at a number of colleges. The system can encourage students to engage in and progress through the college application process via a series of just-in-time messages (e.g., SMS, email, social network), and can enable increased levels of communication via modern channels (e.g., mobile, SMS, email, Facebook) between students and their school counselors who can use the college admission messaging system to track their students' steps towards college enrollment through a web-based dashboard. The college admission messaging system can also provide a communication tool for colleges to connect with and track their applicants as well as iOS and/or Android mobile applications for parents and students. An objective of the college admissions messaging system and related methods is to empower students and families by providing just-in-time information related to the college application process so that students do not miss any steps along the way. In addition, a college admissions messaging system can be designed to support school counselors who can benefit from a tool that allows them to see the steps their students have or have not completed in the college application process (without having to track them down personally), which will allow for more targeted outreach as well as the ability to intervene earlier so that students can fulfill their desire to attend college.

In general, in an aspect, the invention provides a computerized method for assisting a student to complete the college application process including receiving responses from a user based on a questionnaire, such that the received responses are stored on a computer database, generating, by at least one computer, a message list based on one or more responses received from the user, such that the message list includes a plurality of messages, sending each message in the message list to the user based on the current date, receiving a response update from the user for at least one of the sent messages, determining if the response update triggers a warning condition, and displaying the warning condition on a dashboard.

Implementations of the invention may include one or more of the following features. Generating at least one additional message based on at least one response update received, and sending at least one additional message to the user. Receiving a response update from a user for at least one of the additional messages. Receiving mentor contact information from the user, and sending each message in the message list to the user and the mentor. The messages are sent via email, SMS or via a social network messaging system. Receiving a custom message from a counselor, and including the custom message in the message list.

In general, in another aspect, the invention provides a college admissions messaging system including a user registration component operative to present students a college application questionnaire, a database component operative to maintain a database identifying students and their corresponding responses to the college application questionnaire, a message generation component operative to generate one or more electronic messages to the students corresponding to the due dates associated with their respective responses, a message sending component operative to send the one or more electronic messages to a personal communication device associated with each of the students, and a counselor dashboard component operative to display a summary of the messages sent to the students.

Implementations of the invention may include one or more of the following features. A message receiving component can be operative to receive a response update from the students and to store the response update in the database component. The counselor dashboard component can operative to display a summary of the response updates. A custom message generation component can be operative to receive a custom message from a counselor, such that the message sending component is configured to send the custom message to one or more students. The message sending component can be configured to send messages to the students via SMS, email, and social network messaging systems. The registration component can be operative to receive contact information associated with a student's mentor, the database component can be operative to store the mentor's contact information, and the message sending component can be operative to send one or more electronic messages to the mentor's contact information.

In general, in another aspect, the invention provides a computer-readable medium having computer-executed instructions for performing a method including presenting a user with a college application questionnaire, receiving the user's responses to the college application questionnaire, sending the responses to an application server, receiving a electronic messages over a cellular network, such that the content of the messages is based on the responses provided to the application server and the current date, sending a reply to one or more of the electronic messages, such that the reply includes an update from the user, and presenting the user with a dashboard interface, wherein the content of the dashboard is based on the user's responses to the questionnaire and the received messages.

Implementations of the invention may include one or more of the following features. The electronic messages can be SMS messages. The computer readable medium can include instructions for receiving the college application questionnaire from an application server, and instructions for receiving additional college application questions from an application server based on the user's responses to the college application questionnaire. The computer readable medium may also include instructions for receiving the user's responses to the additional college application questions.

These and other capabilities of the invention, along with the invention itself, will be more fully understood after a review of the following figures, detailed description, and claims.

### BRIEF DESCRIPTION OF THE FIGURES

FIG. 1 is a system diagram of an exemplary college admissions messaging system.

FIG. 2 is an exemplary flow diagram of a college admissions messaging method.

FIG. 3 is an exemplary flow diagram of a process for creating custom within a colleges admissions messaging system.

FIG. 4 is a conceptual web site diagram of an exemplary user interface for displaying and receiving college admissions messaging information.

FIG. 5 includes screenshots from a model user interface configured to provide orientation information and receive basic information about a new student user.

FIG. 6 includes screenshots from a model user interface configured to receive contact information and application progress information from a student user.

FIG. is screenshot from a model user interface configured to receive social networking information from a student user.

FIG. 8 is an exemplary user interface configured to provide a counselor a summary of responses received from students.

FIG. 9 is an exemplary user interface configured to provide a counselor a summary of students with warning active variables.

### DETAILED DESCRIPTION OF PREFERRED EMBODIMENTS

Embodiments of the invention provide techniques for generating, sending, responding to, and displaying college admission messages. This system is exemplary, however, and not limiting of the invention as other implementations in accordance with the disclosure are possible.

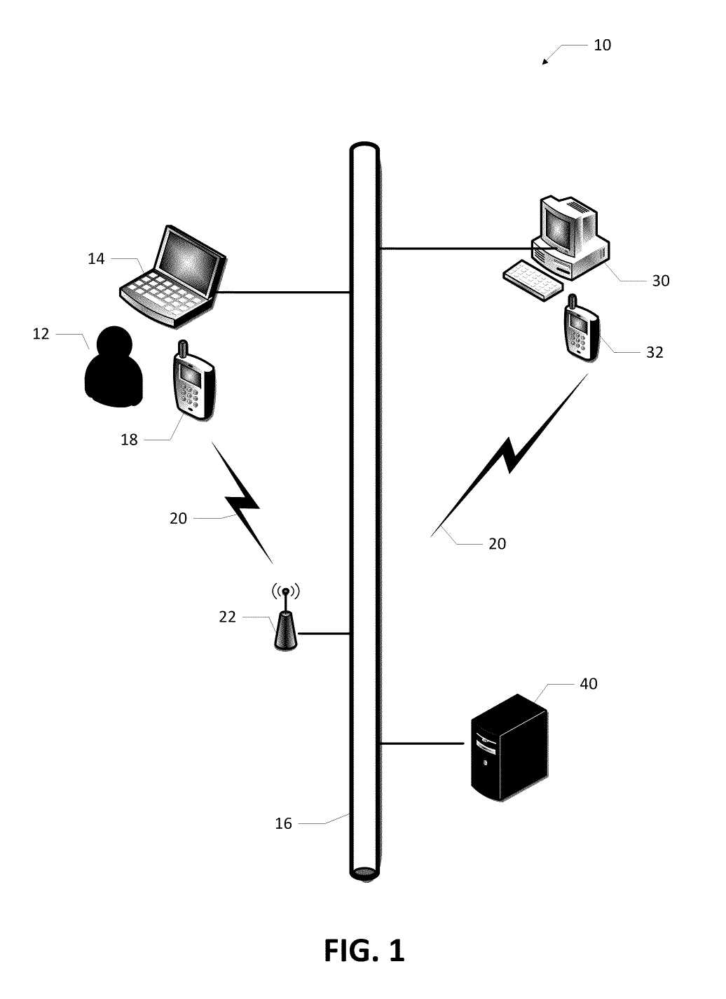

Referring to FIG. 1, a system diagram of an exemplary college admission messaging system 10 is shown. The system 10 can include one or more users 12, a user computer 14, a computer communication system such as the Internet 16, a user cellular telephone 18, a radio communication system 22 configured to transmit and receive radio signals 20, a mentor computer 30, a mentor cellular telephone 32, and an application server 40. The user computer 14, the mentor computer 30, and the application server 40 can be configured to communicate over the computer communication system 16. The cellular telephones 18, 32 can be part of a cellular network capable of accessing the computer communication system 16 via wired or wireless connections. The cellular telephones 18, 32 can also be smart phones such as the Apple iPhone or Motorola Droid running corresponding operating systems. The computers 14, 30 can be personal laptops, tablets, or desktops, such as IBM-compatible computers running the Windows™ operating systems, and/or Apple computers running the Mac OS, or other operating systems. The application server 40 can include one or more processors and memory units, distributed over one or more locations, and can be configured to be compatible with one or more programing interfaces such as Java 6, JFS2 (including AJAX), SpringFramework 3, Tomcat 6, MySql 5, Linus/UNIX, Subversion, Maven 2, Ibatis 3, and the like. The application server 40 includes a database, such as a relational database program or one or more flat files. The computers 14, 30, 40, and cellular phones 18, 32 are configured to store and execute computer-readable instructions to perform the processes described herein. Such instructions can be stored on a computer-readable medium such as computer memory units, conventional hard-disks, CD-ROMS, DVDs, Flash ROMS, nonvolatile ROM, and RAM.

In general, in an embodiment, the college admission messaging system 10 can provide one or more electronic messages to the cellular phones 18, 32 to help guide high school students (e.g., one or more users 12) through the multitude of complex and time consuming steps leading up to and through the college application process. The messages can arrive via a cellular network 20 (e.g., SMS messages, HTML, email), and can be delivered via the computer communication network 16. The application server 40 can included a database configured to provide the electronic messages based on specific responses received from a user 12. The messages can provide the user 12 with accurate and timely college admissions information so that they do not miss critical steps in the college application process. The application server 40 can also serve as a warehouse for frequently asked questions associated with the college application process.

The college admission messaging system 10 can also complement the work of school counselors, mentors, coaches, parents, and other professionals charged with shepherding students and families through the college application process (e.g., these individuals are described herein by the general terms “mentors” or “counselors”). The computers 14, 30 can communicate with the application server 40, and be configured to display an interactive dashboard to enable mentors to view and monitor their students' (e.g., users 12) progress as it relates to the college application process. The dashboard can be configured to help identify students who are in need of assistance. The dashboard can allow mentors to ping (e.g., send an electronic message to a cellular phone 18 via the network 22, 20, or to a computer 14 via the communication network 16) their students with custom messaging. The dashboard also can assist mentors in gathering data and printing reports related to the application process. For example, when the mentor is a public school counselor with a caseload of over 400 students, finding time to have meaningful conversations with each student can be a challenge. The college admissions messaging system 10 can assist school counselors to work proactively, and to systematically target students who are lagging behind in the college application process.

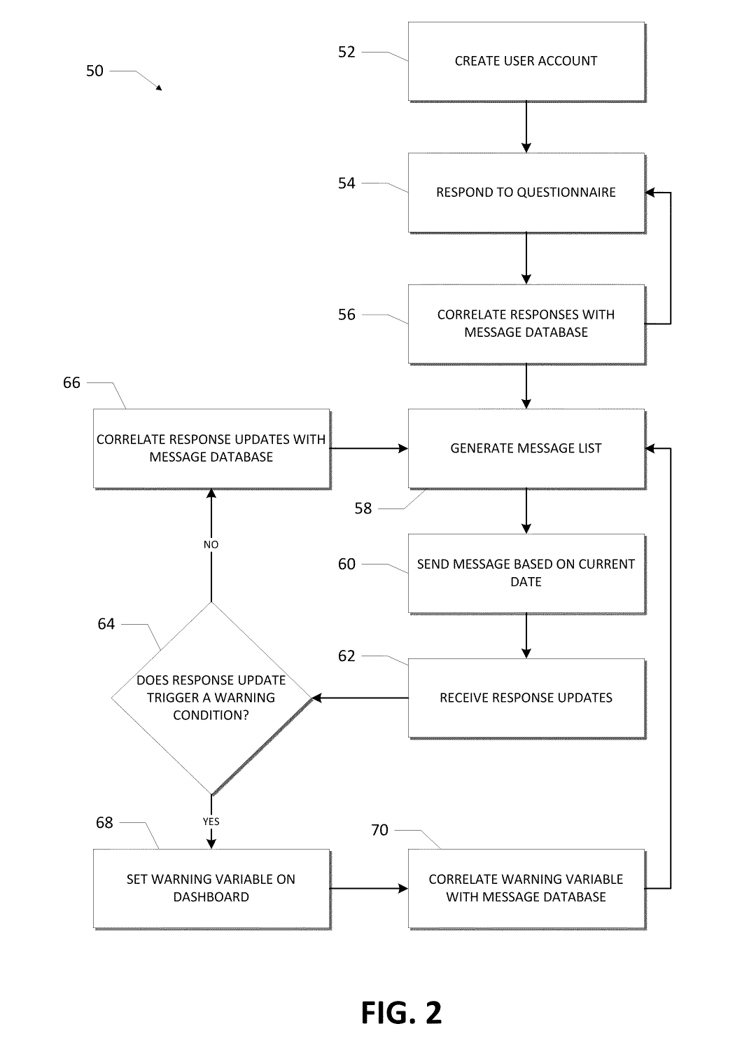

In operation, referring to FIG. 2, with further reference to FIG. 1, a process 50 for using the system 10 includes the stages shown. The process 50, however, is exemplary only and not limiting. The process 50 may be altered, e.g., by having stages added, removed, or rearranged.

At stage 52, the user 12 can utilize the computer 14, or the cellular phone 18, to access a web application running on the application server 40. For example, the user 12 can utilize a web browser (e.g., Internet Explorer, Firefox, Safari) to enter personal information such as name, date of birth, gender, ethnicity, and planned graduation date. The user 12 can also provide contact information associated with their cell phone 18 as well as an email address. The user account information can be stored on the application server 40. In an embodiment, the user can utilize an application (i.e., an “app”) on a cell phone or smart phone to create a user account.

At stage 54, the user 12 can respond to a questionnaire provided by the application server 40. For example, the user 12 can utilize a web browser to provide answers related to their college application efforts. The application server 40 is configured to generate out-going messages based on the user's responses to the questions. In general, the questions can relate to the user's current progress in the college application process. Sample questions can include:

“Have you talked to a counselor about applying to colleges?”

“Have you completed the SATs?”

“Have you received letters of recommendation?”

“Have you sent applications to your top college choices?”

“Have you met with anyone at your top college choices?”

The answers to the questions can be captured via text boxes, radio buttons, or other objects in a graphical user interface, and can persist within a database on the application server 40. In an embodiment, the questions and answers can persist on the client computer 14 or mobile device 18 in file and synchronized with the application server (e.g., XML flat file, local application file). The questions can be tailored to many other topics as well. As an example, and not a limitation, other question topics can include:
a. Proper Course Selection
b. Extracurricular Activities
c. Resume Building
d. College Admissions Testing (e.g. ACT, SAT, TOEFL, AP, etc.)
e. College Essay Writing
f. Finding Fit and the College Search Process—Researching Colleges
g. Financial Aid
h. Scholarships
i. Initiating and Completing College Applications
j. Interviewing for Colleges
k. Arranging College Visits
l. Attending College Fairs
m. Involving Adults for Support (e.g. family members, friends, mentors, teachers, counselors, etc.)
n. Selecting the Right College
o. Teacher recommendations

At stage 56, the responses received from the user 12 are correlated with a message database stored on the application server 40. The responses may impact messages in one or more of the question topics. The questionnaire can be dynamically presented. That is, subsequent questions can be presented based on previous responses. For example, if a user 12 identifies a particular college, then additional questions, and/or a subset of messages in other topics such as course selection, financial aid, arranging college visits, and essay question requirements will be required. Conversely, a subset of messages in different topics may be eliminated based on the user's responses.

At stage 58, the application server 40 can be configured to generate a message list (i.e., construct a message path) based on one or more responses entered by the user. For example, if the user 12 responds that they have not taken the SAT, then the application server 40 can construct a message path comprised of information associated with the SAT. Similarly, if the user 12 identifies a mentor, then the application server 40 can be configured to send messages to the mentor as well as the user 12. In an embodiment, the message path constructed for the user 12 and the mentor can be similar (i.e., directed towards the same goal) but the content of the message will be different based on the perspectives of the user and the mentor. For example, a message regarding the SAT sent to the user 12 may state “Have you registered for the SAT?” while the similar message sent to the mentor may state “Make sure you ask [USER] if they have completed their SAT registration form.” The user-mentor message paths need not be a one-for-one structure. Continuing the example, the mentor may receive additional messages containing, for example, information about the costs required to register for the SAT or information about SAT preparation courses that the user may take. Other such message paths are also within the scope of the invention.

At stage 60, the application server 40 can send messages to one or more of the users and/or mentors. The messages can be comprised of SMS messages sent over cellular communication network to a user's and/or mentor's cell phone or smart phone 18, 32. In an embodiment, the messages can include email, or other social networking messaging services (e.g., Facebook, Twitter, Linkedln). As an example, and not a limitation, users and mentors can receive messages at a rate that depends upon the user's progress, next steps, and responses. The messages may be received monthly, weekly, daily, and some combination of monthly, weekly and daily. There may be months when the user and mentor may not receive a significant number of messages. There may also be months when the user and mentor receive many messages. This may depend on what the user has or has not accomplished and as well and current date (i.e., when a deadline is approaching, the number messages sent can increase). The messages may also include links to relevant web pages (e.g., testing centers, college web sites), as well as links to electronic documents/files stored on the application server 40 to allow the users and mentors to access detailed information about the college application process, find more helpful links, change personal settings, view select college profiles and initiate applications to colleges.

At stage 62, the user and/or mentor can provide response updates to the received messages. Not all messages, however, will require such a response. For example, some messages may be “information only,” and hence will be sent without a mechanism to receive a response. In an embodiment, the messages sent to the users and/or mentors can include a response mechanism such as a “yes-no” checkbox, a text box, or other user field configured to receive and return information from the users and/or mentors. For example, a message such as “Have you registered for the SAT?” can be configured with a check box object for the user 12 to update their response to this question. The update response can be received and stored on the application server 40. Also, a lack of a response or other system error can be stored as an update value.

At stage 64, the received response update can be evaluated to determine whether a warning condition is triggered. For example, if a user 12 answers “No” to a message that states “Are your financial aid materials prepared?” then a warning condition can be triggered. In embodiment, if an error message is returned (i.e. an undeliverable error message is received), or if a user 12 has been inactive for a number of days, then a warning condition may also be triggered.

At stage 66, the response updates can be correlated with the message database. For example, if a user 12 indicates a desire to evaluate a new college, or provides response updates which may impact the college application process, new questions and/or new message topics may be needed. Subsequent messages can include questions from the questionnaire database. In an example, a user 12 can indicate a new mentor which may require correlating new topics. Once the topics are determined, a revised message list can be generated at stage 58.

At stage 68, if a warning condition is detected then a warning variable can be displayed on a dashboard. The dashboard can be configured to display a summary of one or more of the students associated with the warning condition. For example, if one or more users 12 have been inactive for a number of days, then those students can be listed on the dashboard with an appropriate summary of the warning condition (see FIG. 11).

At stage 70, the system can correlate the warning variable with the messages in the database. In an embodiment, certain message topics (or messages) will be triggered based on the warning condition. A revised message list can be generated at stage 58 based on one or more warning conditions.

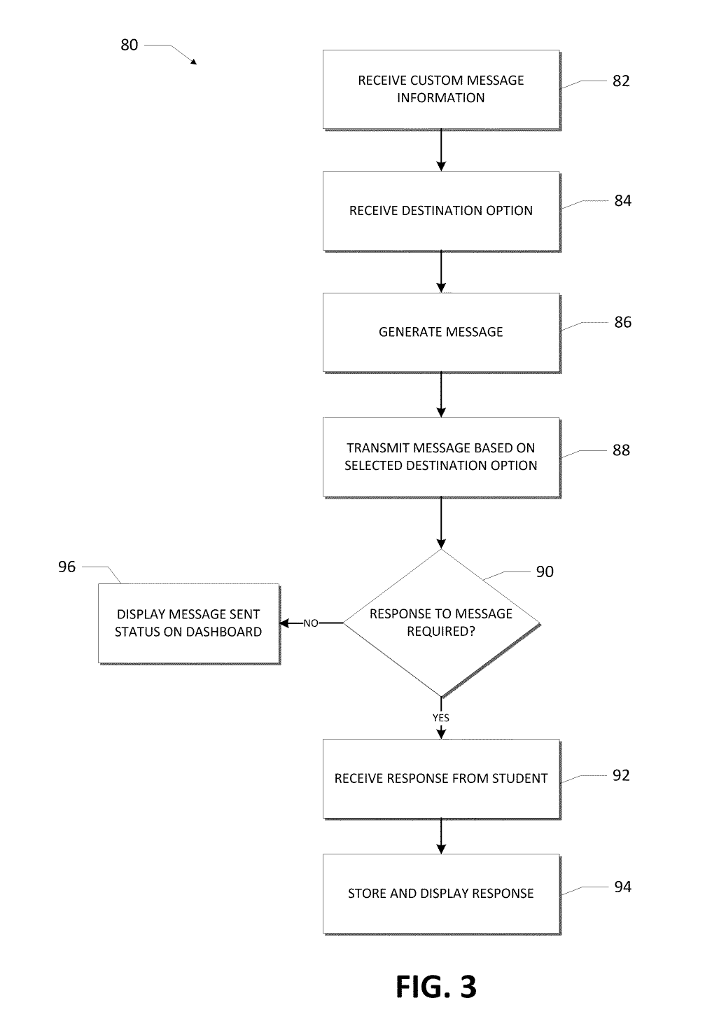

In operation, referring to FIG. 3, with further reference to FIG. 1, a process 80 for creating customer messages with the system 10 includes the stages shown. The process 80, however, is exemplary only and not limiting. The process 80 may be altered, e.g., by having stages added, removed, or rearranged.

At stage 82, a mentor (e.g., school counselor, college admissions staff) can utilize a computer 30 or cellular telephone 32 (e.g., smart phone, tablet) to create a custom message that includes text and/or other information (e.g., links, files, images). In an embodiment, the application server 40 includes a dynamic web page configured to receive the custom message information via a browser on the computer 30 or phone 32. In an example, the computer 30 or phone 32 runs a local application which is configured to provide (i.e., push) the custom message information to the application server 40. In an embodiment, the content of the custom message can be received from a social networking site such as Facebook, Twitter, and Linkedln.

At stage 84, the mentor can select a destination option for the message. For example, a mentor can select a radio button, or other GUI object, to indicate that the customer message is to be sent to an individual student, a group of students, or an entire class of students. Other grouping options may also be used such as by SAT registration date, college choice, ethnicity, and warning indications. The groupings can be derived from queries to one or more data tables included on the application server 40.

At stage 86, the application server can be configured to generate a custom message based on the information received from the mentor and the destination options. At stage 88, the message can be transmitted via email, SMS, or over social networking messaging systems as known in the art.

At stage 90, a determination is made on whether or not the sent message requires a response. If a response is not required, the “sent” status is displayed on a dashboard. If a response is required, the application server 40 is configured to process the response received from the student at stage 92. The response can be stored and displayed at stage 94. The application server 40 can be configured to display responses from individual users, or aggregate responses for a group. For example, a school counselor could send out a custom message such as “Would you like to attend a free seminar titled ‘How to survive your freshman year?’” The application server can be configured to create a dashboard to display a summary of the responses received such as the number of each Yes, No, and No Response.

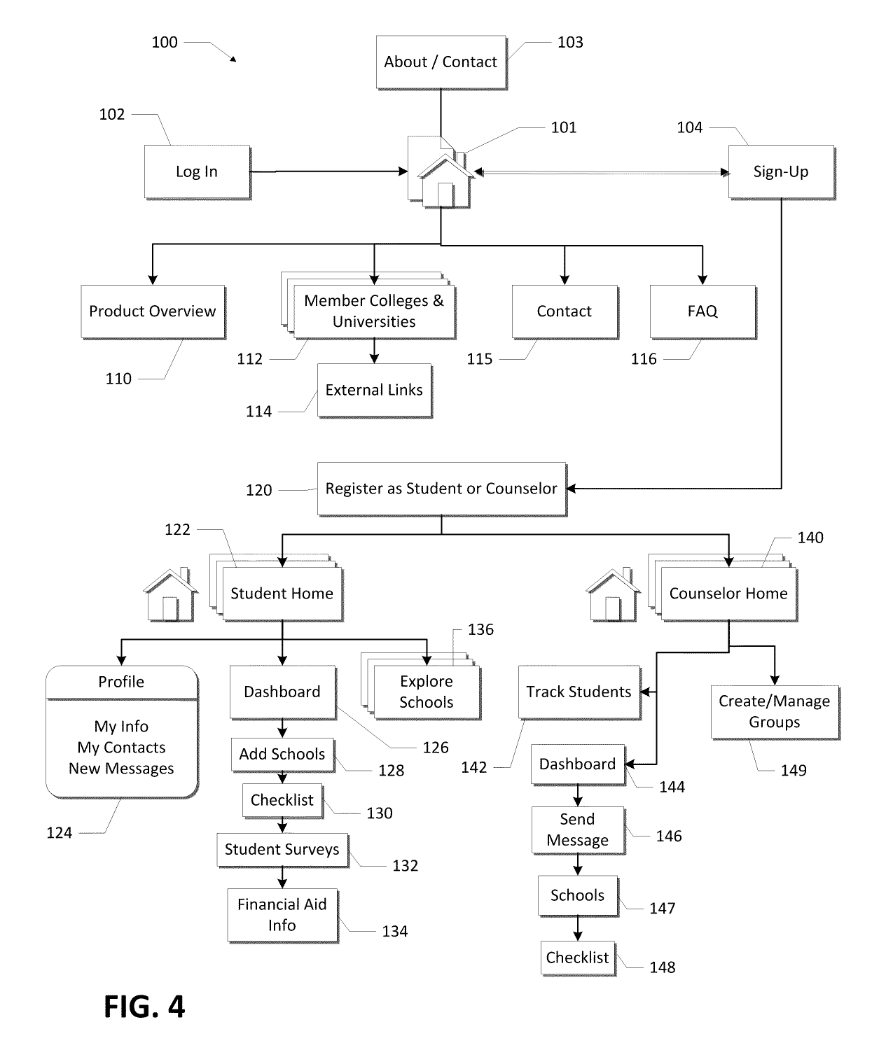

Referring to FIG. 4, an exemplary website 100 is shown. The functionality, arrangement of webpages, and other objects are examples only and not limitations. The application server 40 can be configured to store and execute computer readable code to perform the functions and interactions of the website 100. In embodiment a user 12, or mentor, can access the computer 14, 30 or other Web-enabled device (e.g., smart phones 18, 32) to interact with the website 100. In an embodiment, the website 100 can be a client application which persists on a local computer or personal data appliance (e.g., smart phone, tablet PC), and is configured to send and receive data over a communication link (e.g., the Internet, cellular telephone network) to an application server. The website 100 can include a homepage 101 associated with a URL or other unique identifier. The homepage 101 can be configured to verify the credentials of the user, for example, via a secure login, digital certificate, cookie, or other encryption and security measures known in the art. For a new user (i.e., a user without security credentials), the home page can display general information about the college admission messaging system 10 via an “About/Contact” page 103 or “Product Overview” page 110. They may also activate a link or other data object to enable the user to set up a secure account 104. New users may also have access to a list of member colleges and universities 112 as well as a list of external links 114 associated with the college admissions process. The website 100 may also include objects for new users to contact the website manager 115, and access a frequently asked questions page 116.

Once a new user establishes an account via a sign-up process 104 they can log into the secure portions of the website 100 via the login section 102. A user has the option to register and subsequently log into either a “Student” or “Counselor” portion of the website 100. For example, if a user logs in as a student 120 they are directed to a student home portion 122. If a user logs in as a counselor 120 they are directed to a counselor home portion 140.

A user can utilize the student home portion 122 to access and activate a collection of pages associated with their unique requirements. The student home portion will include a profile group 124 which is comprised of user specific data such as personal contact info, a collection of contacts, and a personal mailbox including sent and received messages. The profile group 124 may also include a “rewards” section comprised of points, or other such tokens, which are awarded to the user based on activities and/or accomplishments associated with the college admissions process. A student user may also access a dashboard 126 which is configured to display information about the user's college admission activities. The functionality associated with the dashboard 126 may include, but is not limited to, adding and removing colleges of interest 128, reviewing and selecting checklist items 130, providing information and reviewing data associated with student surveys 132, and receiving information and assistance associated with obtaining financial aid 134. In an embodiment, the website 100 may also include an explore schools portion 136 which can include Web-enabled content associated with colleges of interest to the student. For example, the explore school section 136 may include virtual tours of a school campus, videos of classroom lectures, or other content that the college can use to recruit new students. The explore schools section may also include a collection of “school stores” where a user may exchange their “reward” points for virtual (e.g., mp3 files of school fight songs, photos) and physical (e.g., books, clothing, sports tickets) items.

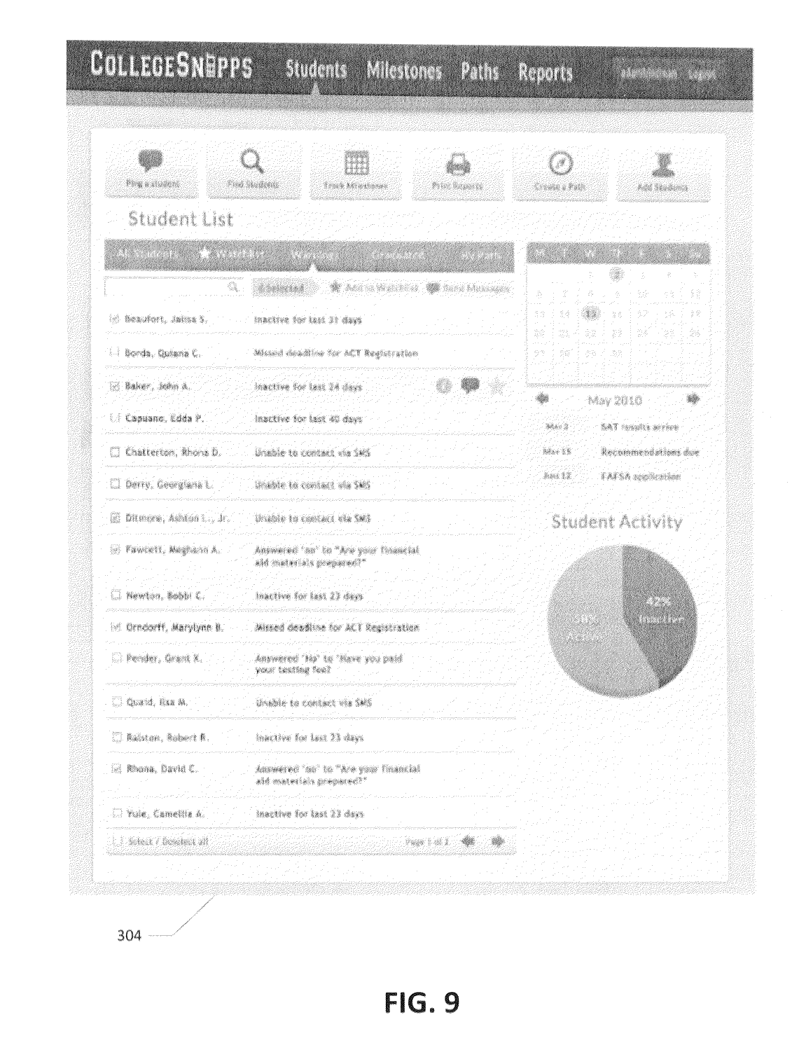

A user (i.e. mentor) can utilize the counselor home portion 142 to interact with data associated with students in their charge. A track students page 142 can be configured to display a list of the students the mentor is working with. The track students page 142 can be interactive such as with point-and-click (and similar functionality) for sorting and displaying data as known in the art. A dashboard page 144 can provide summary information regarding the counselor students, activities, messages, reports, and message paths. For example, a dashboard page 144 can provide the counselor with a list of students who have registered for college admission messaging but have been inactive for a number of days (see FIG. 9). A “send message” page 146 can be configured to receive message information from a mentor and enable the mentor to transmit a message to one or more students. For example, a mentor can assign attributes to students (e.g., class year, ethnicity, colleges of interest, SAT scores, questionnaire responses, etc.) and then send messages to the students based on one or more group assignments. A create/manage groups page 149 can include graphical objects (e.g., radio buttons, drop-down lists, drop and drag text boxes, data filters, column selection) to facilitate the creation and management of such groups. The schools webpage 147 can include admissions information about schools participating in the college admissions messaging program. For example, the schools page 147 can include contact information for admissions offices, admissions profiles, admissions requirements, financial aid information, and other information useful to the admissions process. A checklist page 148 can include a collection of checklists associated with events in the admissions process. As an example, and not a limitation, checklists can be associated with particular colleges, testing events, training events, student groups, and pre-graduation activities. In an embodiment, a checklist can be a college application that is pre-populated with a portion of the student's personal information. For example, if a student indicates that Boston College is one of their colleges of interest, they can receive a message stating “Boston College is one of your colleges of interest. Would you like to apply?” If the student answers “yes,” then a pre-populated Boston College admission form is presented to the student for completion. The system 10 can also send a message to the admissions office at Boston College to allow the office to track the student's progress in the completion of the application.

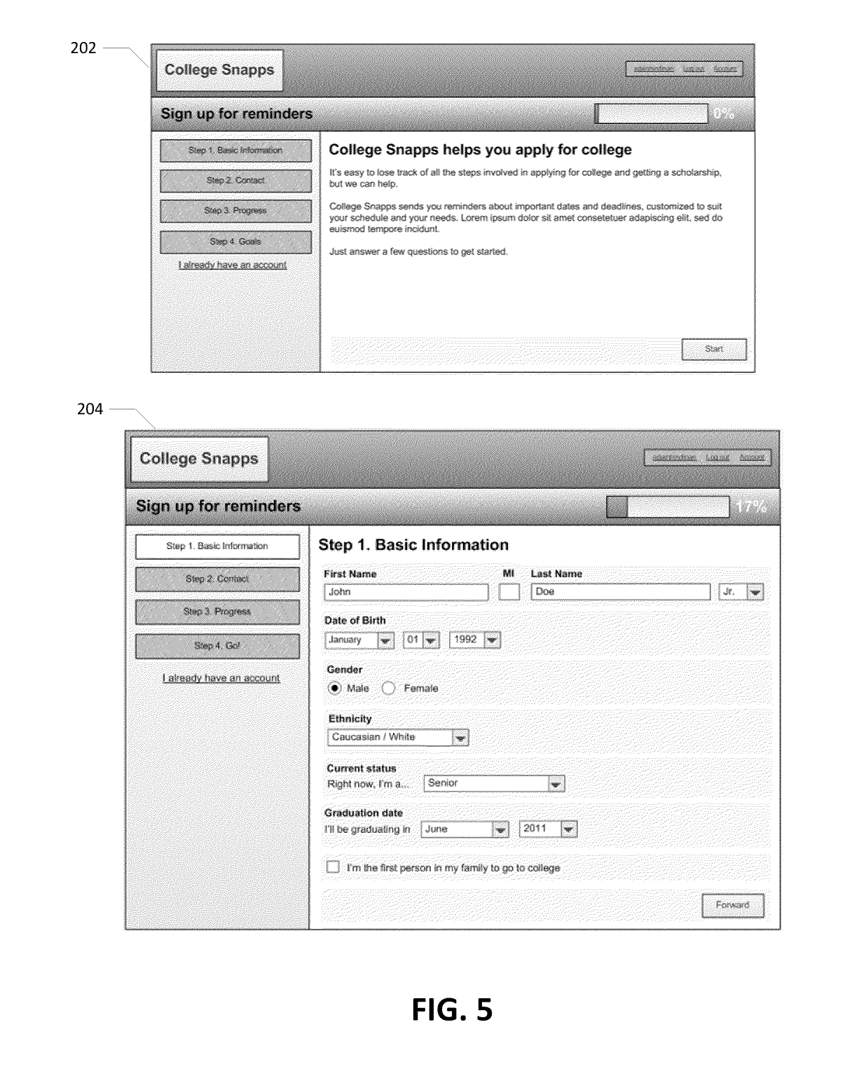

Referring to FIG. 5, which further reference to FIG. 4, screenshots of a model user interface for providing orientation information and receiving basic information about a student user are shown. In operation, in an embodiment, a student user 12 can utilize a website 100 to register as a student at stage 120. As an example, and not a limitation, the user 12 can receive an interactive window 202 to start the registration process. This initial window 202 can display information about the college admissions messaging application and the registration process, including a summary of the information required for registration. After presenting the user 12 with the initial window 202, the application can display an interactive window for receiving basic information 204. As an example, and not limitation, the website 100 can utilize dynamic webpages for receiving information such as a user's name, date of birth, gender, ethnicity, current status, graduation date, and other information relevant to the college admission process (e.g., such as asking if the student is the first person in their family to go to college). The information entered by the user can be stored on the application server 40.

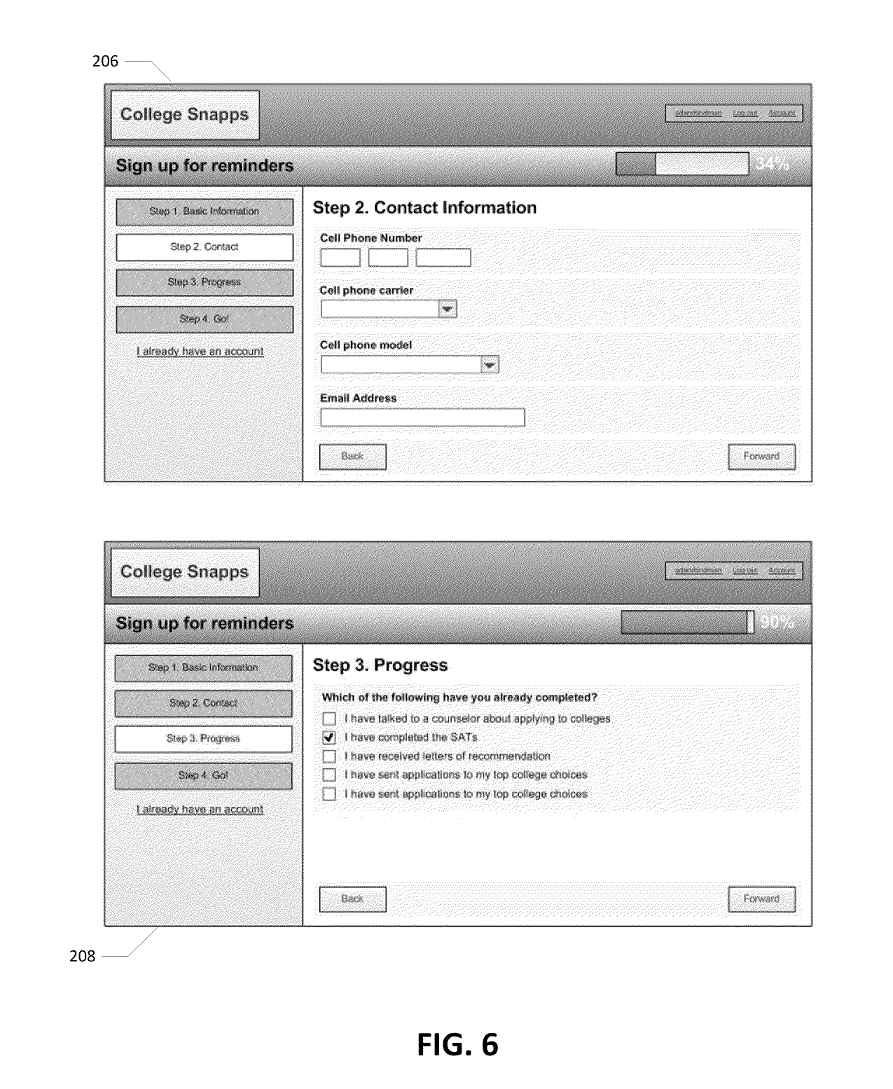

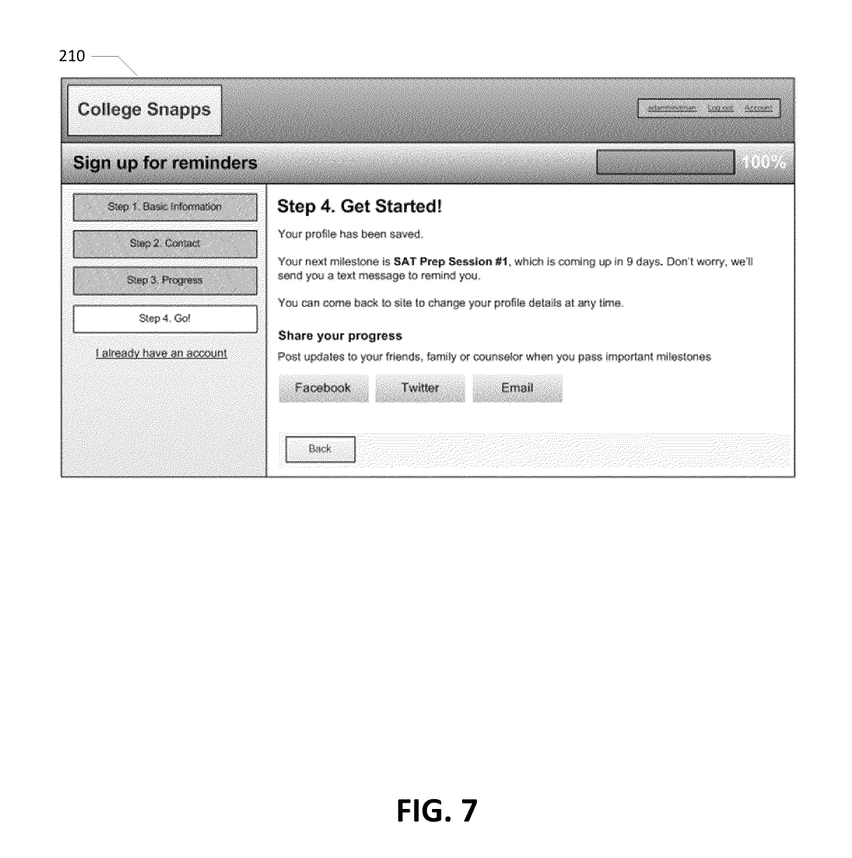

Referring to FIG. 6, with further reference to FIG. 4, screenshots of a model user interface configured to receive contact information and application progress information from a student user are shown. These screens can be part of the registration process 120 of the college admission messaging website 100. The user 12 can be presented with a dynamic webpage 206 configured to receive contact information. In an embodiment, the contact information can include the user's cell phone number, the corresponding cell phone carrier, and an e-mail address. Optionally, the user may also provide information about the cell phone or smart phone they are using, as well as the corresponding operating system executing on the phone. Such information can be used for formatting messages prior to transmission to ensure the information is properly displayed on the phone. In an embodiment, the user 12 may also include social networking account information so that the messaging system can provide messages to their social networking account. The user can also be presented with a questionnaire 208 related to their college application efforts thus far. The questionnaire can be configured to receive text input (e.g., dates, names, short answers) as well as multiple-choice answers (e.g., check boxes, radio buttons, and constrained list selections). The questions provided on the questionnaire can be dynamically assembled based on previous input, including previous questionnaire answers, received from the user or counselor. For example, if one question is “What is your desired field of study?” and the user response with “Engineering,” subsequent questions can be added to the questionnaire based on admissions issues associated with admission to engineering colleges (i.e., high school course curriculum, science awards, technical work experience). Other dynamic questioning paths are also within the scope of the invention.

Referring to FIG. 7, a screenshot of a model user interface configured to receive social networking information from a student user is shown. In an embodiment, at the completion of the registration process 120, a student can elect to share their progress with friends, family or counselors when they pass important milestones. For example, when a student completes their college application essays, takes the SAT, receives an acceptance letter, or other milestones, a message can be sent to their Facebook account or other social networking service. In an embodiment, the user 12 can indicate third party (i.e., friends, family, mentors) social networking accounts, email address, or cell phone numbers to receive the milestone updates.

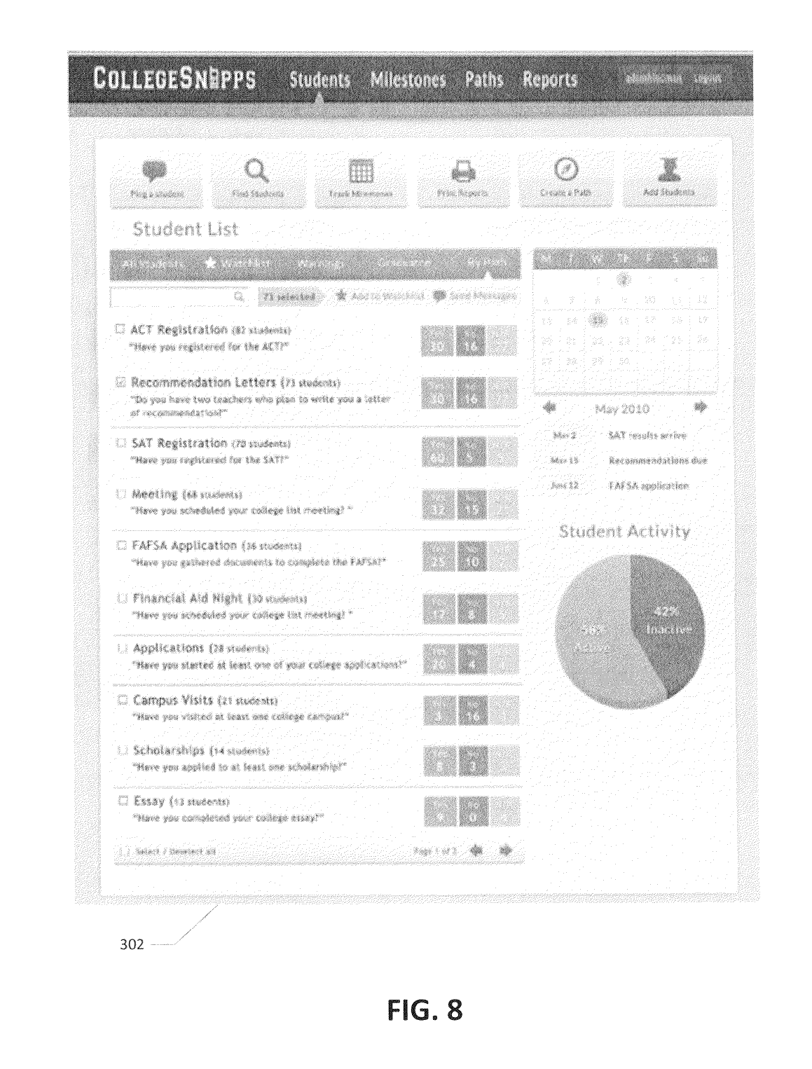

Referring to FIG. 8, with further reference to FIG. 4, an exemplary user interface configured to provide a counselor a summary of responses received 302. This interface can be included in a counselor's dashboard 144 in the website 100. As an example, and not a limitation, the interface 302 can include a series of command buttons at the top to perform a variety of functions such as pinging a student, finding a student in the database, tracking milestones, printing reports, creating message paths, and adding students. In an embodiment, the interface 302 can include a summary of responses received from students grouped by the outgoing messages. For example, as indicated on the screenshot 302, for the message titled “ACT registration,” the interface indicates that 30 “Yes” responses and 16 “No” responses have been received, with 27 students “Not Responding.” In an embodiment, the counselor can select one of the message paths and request the system to resend the message to the students that have not responded. The interface 302 can also include a summary calendar to highlight significant dates in the college application process, as well as provide graphical objects to indicate/summarize student activity (e.g., pie charts, bar graphs, Venn diagrams).

Referring to FIG. 9, with further reference to FIG. 4, a screenshot of an exemplary user interface configured to provide a counselor a summary of students with active warning variables 304 is shown. The interface 304 can be part of a counselor's dashboard 144 of a website 100. As an example, and not limitation, the interface 304 can include a list of students that have warning conditions associated with one or more responses or questionnaire answers the students have provided. A warning condition may also be triggered based on system errors, or on a student's level of inactivity within the messaging system. For example, as disclosed in the interface 304, the student “Pender, Grant X.” is associated with a warning because he answered “no” to the question “Are your financial aid materials prepared.” The counselor can utilize the interface 304 to generate messages or create additional message paths for a particular student, or student group. Continuing the example above, a counselor could utilize the interface 304 to send Mr. Pender a custom message to request a meeting. In an embodiment, a counselor can select multiple students to send each a common custom message.

The screenshots provide in FIGS. 5-9 are examples only, and not a limitation. The data display and input objects can be performed in a variety of ways. In addition to the dynamic web pages, the website 100 can be assembled as a client application which persists on a remote computer or PDA. For example, the website 100 can be constructed on Windows.NET framework utilizing the Microsoft Visual Studio Integrated Development Environment. Forms and other graphical interface objects can be constructed to interact with different data structures, such as XML flat files, OBDC data connections, and relational databases. A .NET application can be configured and compiled to run on a Web Server, client computer, or mobile application. Other development environments and deployment strategies may also be used.

In operation, in an embodiment, the college admissions messaging system can be deployed under the product name “CollegeSnapps.” For example, the CollegeSnapps application can prompt high school students (grades 9-12) to engage in and progress through the college application process via a series of SMS text messages called “snapps.” Students can receive helpful hints, reminders, and notices during designed periods of times that coincide with the critical steps students must take in order to apply to college. As an incentive, when students complete these steps, or when they respond to “snapps,” they will receive “snapp points.” The greater, longer or more complex the task, the more “snapp points” the student will receive.

In addition to the CollegeSnapps SMS text program, there can be a CollegeSnapps mobile website which contains more detailed information about the college application process for students as well as profiles of select colleges and universities. Students can initiate a short application to these colleges through the CollegeSnapps website. Students can also access a “frequently asked questions” section and click through to other helpful websites. In addition, there can be “CollegeSnapps School Store” where students can redeem their “snapp points” for a variety of items (e.g. song downloads, college paraphernalia, travel vouchers to visit colleges).

Through the CollegeSnapps Dashboard function, students can invite their guidance counselors or other educators and professionals to view and track their progress. The Dashboard can also function as an interface so that invited counselors or educators can share information with their students who are using CollegeSnapps (e.g. sending out a “snapp” about an upcoming college visit).

In an embodiment, CollegeSnapps can allow select colleges to advertise on the website in the form of a school profile. SMS text messages about the participating colleges can also go out on a weekly and monthly basis (i.e. “College of the Week” or “College of the Month”). These colleges and/or universities can sign an annual contract with CollegeSnapps and can receive support and data reports about student interest and follow through.

In an embodiment, CollegeSnapps can be deployed via the commercial application scene, and can be a platform specific applications for mobile phones (e.g., iPhone, Google's Android, and Windows Mobile). In these formats, CollegeSnapps can provide a more in-depth look into the participating colleges through multimedia (e.g. virtual tours). It can also walk students through a rigorous “finding fit game”—designed to increase their knowledge of critical terms that are often used when searching for colleges while helping the student determine what it is that they are looking for in a college.

In operation, once a high school student signs on to CollegeSnapps, they can be prompted to answer a series of questions—the answers to which will activate the proper sequence of SMS text messages. For example, if a junior in high school signs on in December, then CollegeSnapps can ask questions that will determine what work the student has accomplished and what still needs to be done. Once the proper SMS text sequence is initiated, the student will begin to receive a monthly series of SMS text messages that can, for example:

1. Remind the student to complete tasks related to the college application process in a timely fashion (e.g. register for the SAT);

2. Provide the student with information about select colleges (i.e. college of the month profile);

3. Provide students with fast facts and quick tips about certain aspects of the college application process;

4. Allow the student to accumulate points for completion of SMS text message tasks that are redeemable in CollegeSnapps' online school store;

5. Prompt the student to communicate with their guidance counselor or adult who is helping them with the college application process;

6. CollegeSnapps can feature an “Invite Your Counselor” feature. If a student chooses to do so, the counselor or adult will receive an email, informing them that their student has invited them to track their progress on CollegeSnapps

7. This individual can also receive a Dashboard application that can provide them with an electronic view of the student's progress and actions

8. The individual can send the student text and email messages through the Dashboard in the event that they would like to share information with the student

CollegeSnapps can be sold as an application for cell phones with data plans (e.g. iPhone, Google Droid, etc.). It can send SMS text messages as prompts and reminders to students. However, it can also provide more multimedia components such as virtual campus tours, more direct interface with select college websites as well as helpful links. With improved graphical capabilities in such smart phones, the “CollegeSnapps School Store” can be more robust with more capabilities through the CollegeSnapps mobile website for the students to select exactly what merchandise they want. It can also provide SAT and/or ACT preparation in the form of “the word of the day” or “the problem of the day” for students to gain more practice and exposure to the exam. In addition, students can perform a more detailed college search by critically dissecting college differences and characteristics in order to help the student to find the best fit possible. A virtual counselor can be added to ask more real-time questions.

The college admissions messaging system and methods can also support and interact with students who are enrolled in college. It can provide critical information on how to persist and thrive in college through periodic messages. A college may implement the system 10 to deliver useful information to their enrolled students. College counselors and administrators can create messages paths based upon the school culture, course offerings, and academic policies. Warning conditions can be established to help identify and communicate with struggling students. For example, counselors and/or instructors can utilize a dashboard to indicate that one or more students may require extra instruction, to input assignment due dates for a class, or to identify students who will be called upon in the next lecture. In an embodiment, a student's progress reports (e.g., report card, exam results) can be used to set a warning condition. Messages such as “Have you set up an appointment with the writing center?” or “Have scheduled a meeting with your faculty advisor?” could be sent based on warning conditions. In an embodiment, receiving responses from a questionnaire can be completed during an initial orientation and on a periodic basis. For example, a Freshman may fill out an orientation questionnaire to indicated that they have concerns about their language skills. A message path can be created to inform them when relevant language courses and extra instruction activities are available. Similar message paths can be created for other academic topics as well. A periodic questionnaire can be presented to a student, and or advisor, based on performance milestones such as grade point average. For example, if a student falls below a certain level a “Study Habits” questionnaire can be presented to the student. Responses to the questionnaire can be used to generate message paths associated with the student's academic responsibilities (e.g., “Your essay for Economics 101 is due in two weeks, have you completed your outline?” “Tomorrow's topic in Physics is Moore's Law, it seems twice as likely that you are going to be asked to participate in the lecture—are you ready?”).

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A computerized method for assisting a student to complete the college application process, comprising:
receiving a plurality of responses from a user based on a questionnaire, wherein the received responses are stored on a computer database;
generating, by at least one computer, a message list based on one or more responses received from the user, wherein the message list includes a plurality of messages;
sending each message in the message list to the user based on the current date;
receiving a response update from the user for at least one of the sent messages;
determining if the response update triggers a warning condition; and
displaying the warning condition on a dashboard.

2. The computerized method of claim 1 further comprising:
generating at least one additional message based on at least one response update received; and
sending the at least one additional message to the user.

3. The computerized method of claim 2 further comprising receiving a response update from the user for at least one of the sent additional messages.

4. The computerized method of claim 1 further comprising:
receiving mentor contact information from the user; and
sending each message in the message list to the user and the mentor based on the current date.

5. The computerized method of claim 1 wherein each message in the message list is sent via email.

6. The computerized method of claim 1 wherein each message in the message list is sent via a Short Message Service (SMS).

7. The computerized method of claim 1 wherein each message in the message list is sent via a social network.

8. The computerized method of claim 1 further comprising:
receiving a custom message from a counselor; and
including the custom message in the message list.

9. A college admissions messaging system, comprising:
a user registration component operative to present students a college application questionnaire;
a database component operative to maintain a database identifying students and their corresponding responses to the college application questionnaire;
a message generation component operative to generate one or more electronic messages to the students corresponding to the due dates associated with their respective responses;
a message sending component operative to send the one or more electronic messages to a personal communication device associated with each of the students; and
a counselor dashboard component operative to display a summary of the messages sent to the students.

10. The college admissions messaging system of claim 9 comprising a message receiving component operative to receive a response update from the students and to store the response update in the database component.

11. The college admissions messaging system of claim 10 wherein the counselor dashboard component is operative to display a summary of the response updates.

12. The college admissions messaging system of claim 9 comprising a custom message generation component operative to receive a custom message from a counselor, wherein the message sending component is configured to send the custom message to one or more students.

13. The college admissions messaging system of claim 9 wherein the message sending component is configured to send messages to the students via a method selected from the group consisting of SMS, email, and social network messaging systems.

14. The college admissions messaging system of claim 9 wherein:
the registration component is operative to receive contact information associated with a student's mentor;
the database component is operative to store the mentor's contact information; and
the message sending component is operative to send the one or more electronic messages to the mentor's contact information.

15. A computer-readable medium having computer-executed instructions for performing a method comprising:
presenting a user with a college application questionnaire;
receiving the user's responses to the college application questionnaire;
sending the responses to an application server;
receiving a plurality of electronic messages over a cellular network, wherein the content of the messages is based on the responses provided to the application server and the current date;
sending a reply to one or more of the electronic messages, wherein the reply includes an update from the user; and
presenting the user with a dashboard interface, wherein the content of the dashboard is based on the user's responses to the questionnaire and the received messages.

16. The computer-readable medium of claim 15, further comprising computer-executable instructions for receiving the college application questionnaire from an application server.

17. The computer-readable medium of claim 15, further comprising computer-executable instructions for receiving additional college application questions from an application server based on the user's responses to the college application questionnaire.

18. The computer-readable medium of claim 17, further comprising computer-executable instructions for receiving the user's responses to the additional college application questions.

19. The computer-readable medium of claim 15, wherein the electronic messages are SMS messages.
